(19) United States
(12) Patent Application Publication
(10) Pub. No.: US 2006/0018549 A1
(43) Pub. Date: Jan. 26, 2006

(54) System and method for object characterization of toboggan-based clusters

(76) Inventors: Jianming Liang, Paoli, PA (US); Luca Bogoni, Philadelphia, PA (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/174,028

(22) Filed: Jul. 1, 2005

Related U.S. Application Data
(60) Provisional application No. 60/589,518, filed on Jul. 20, 2004.

(51) Int. Cl. G06K 9/46

(52) U.S. Cl. 382/190

(57) ABSTRACT

A method for characterizing an object in a digitized image includes providing a digitized volumetric image comprising a plurality of intensities corresponding to a domain of points in an N-dimensional space, forming a toboggan cluster from a subset of contiguous points in said image, said toboggan cluster including a concentration point, extracting a first layer from said toboggan cluster, and computing one or more features from said toboggan layer.

### CROSS REFERENCE TO RELATED UNITED STATES APPLICATIONS

This application claims priority from “Object Characterization following Toboggan-based Clustering”, U.S. Provisional Application No. 60/589,518, of Liang, et al., filed Jul. 20, 2004, the contents of which are incorporated herein by reference.

### TECHNICAL FIELD

This invention is directed to segmentation and characterization of objects extracted from digital medical images.

### DISCUSSION OF THE RELATED ART

Digital images are created from an array of numerical values representing a property (such as a grey scale value or magnetic field strength) associable with an anatomical location points referenced by a particular array location. The set of anatomical location points comprises the domain of the image. In 2-D digital images, or slice sections, the discrete array locations are termed pixels. Three-dimensional digital images can be constructed from stacked slice sections through various construction techniques known in the art. The 3-D images are made up of discrete volume elements, also referred to as voxels, composed of pixels from the 2-D images. The pixel or voxel properties can be processed to ascertain various properties about the anatomy of a patient associated with such pixels or voxels.

The process of classifying, identifying, and characterizing image structures is known as segmentation. Once anatomical regions and structures are identified by analyzing pixels and/or voxels, subsequent processing and analysis exploiting regional characteristics and features can be applied to relevant areas, thus improving both accuracy and efficiency of the imaging system. One method for characterizing shapes and segmenting objects is based on tobogganing. Tobogganing is a non-iterative, single-parameter, linear execution time over-segmentation method. It is non-iterative in that it processes each image pixel/voxel only once, thus accounting for the linear execution time. The sole input is an image's ‘discontinuity’ or ‘local contrast’ measure, which is used to determine a slide direction at each pixel. One implementation of tobogganing uses a toboggan potential for determining a slide direction at each pixel/voxel. The toboggan potential is computed from the original image, in 2D, 3D or higher dimensions, and the specific potential depends on the application and the objects to be segmented. One simple, exemplary technique for defining a toboggan potential would be as the intensity difference between a given pixel and its nearest neighbors. Each pixel is then ‘slid’ in a direction determined by a maximum (or minimum) potential. All pixels/voxels that slide to the same location are grouped together, thus partitioning the image volume into a collection of voxel clusters. Tobogganing can be applied to many different anatomical structures and different types of data sets, e.g. CT, MR, PET etc., on which a toboggan type potential can be computed.

Object segmentation and shape characterization assume that an object of interest has been located by some procedure. For example, in order to segment and characterize polyps in virtual colonoscopy, the polyp candidate may be manually clicked by a user with the mouse or automatically detected by a detection module. Object segmentation provides a collection of pixels constituting the object, while shape characterization aims to compute a plurality of parameters to characterize the object. The segmented object and the computed parameters can be directly displayed to the user or can be used by an automatic module (for instance, a classifier) for further processing. Examples of these parameters include object measurements, such as its longest linear dimension, its volume, its texture, the computation of moments of the intensity, etc. as well as statistical properties computed on these. In case of virtual colonoscopy, examples of further processing include determining if the candidate is a polyp or not; once the candidate is classified as a polyp, the polyp will be measured.

### SUMMARY OF THE INVENTION

Exemplary embodiments of the invention as described herein generally include methods and systems for obtaining global and layered object features following toboggan based clustering. Global features include those features computed on the cluster as a whole, while layer features include those computed following the extraction of layers within the extracted toboggan cluster. The techniques herein described are applicable to images of multiple dimensions and obtained from different modalities.

According to an aspect of the invention, there is provided a method for characterizing an object in a digitized image including providing a digitized volumetric image comprising a plurality of intensities corresponding to a domain of points in an N-dimensional space, forming a toboggan cluster from a subset of contiguous points in said image, said toboggan cluster including a concentration point, extracting a first layer from said toboggan cluster, and computing one or more features from said toboggan layer.

According to a further aspect of the invention, the first layer comprises a surface layer of said toboggan cluster, which comprises those cluster points to which no other cluster points slide.

According to a further aspect of the invention, the features include one or more of the statistical moments of the point intensities of the points in said layer, the statistical moments of the toboggan potential values of the points in said layer, the sphericity of said layer, a direct distance and sliding distance of each point in said layer, a ratio of said direct distance to said sliding distance, or a consistency of a normal direction to a sliding direction of each point in said layer.

According to a further aspect of the invention, the point in said cluster has a toboggan potential value, and further comprising extracting one or more layers from said toboggan cluster wherein each layer comprises cluster points whose toboggan potential value is within a predetermined range.

According to a further aspect of the invention, the method comprises computing, for each layer, one or more statistical moments of the intensities of the points in each said layer, and computing a rate of change of said statistical moments across said layers.

According to a further aspect of the invention, the rate of change is computed with respect to a coordinate system centered on the concentration point of said cluster.

According to a further aspect of the invention, the method comprises computing one or more Fourier descriptors of said rate of change.

According to a further aspect of the invention, the method comprises computing one or more wavelet descriptors of said rate of change.

According to a further aspect of the invention, the method comprises computing, for each layer, one or more statistical moments of the toboggan potentials of the points in each said layer, and computing a rate of change of said statistical moments across said layers.

According to a further aspect of the invention, the rate of change is computed with respect to a coordinate system centered on the concentration point of said cluster.

According to a further aspect of the invention, the method comprises computing one or more Fourier descriptors of said rate of change.

According to a further aspect of the invention, the method comprises computing one or more wavelet descriptors of said rate of change.

According to a further aspect of the invention, the toboggan cluster includes a plurality of concentration points.

According to another aspect of the invention, there is provided a program storage device readable by a computer, tangibly embodying a program of instructions executable by the computer to perform the method steps for characterizing an object in a digitized image.

### BRIEF DESCRIPTION OF THE DRAWINGS

FIG. 1 depicts a non-limiting example illustrating the tobogganing process given a 5×5 2D toboggan potential, according to an embodiment of the invention.

FIG. 2 depicts a toboggan cluster with two layers, according to an embodiment of the invention.

FIG. 3 depicts two extracted layers for a cluster associated with a structure in a 3-dimensional volume, according to an embodiment of the invention.

FIG. 4 depicts a flow chart of a toboggan-based object characterization method, according to an embodiment of the invention.

FIG. 5 is a block diagram of an exemplary computer system for implementing a toboggan-based object characterization scheme according to an embodiment of the invention.

### DETAILED DESCRIPTION OF THE PREFERRED EMBODIMENTS

Exemplary embodiments of the invention as described herein generally include systems and methods for segmenting objects and characterizing shapes in digital medical images. Although an exemplary embodiment of this invention is discussed in the context of segmenting and characterizing the colon and in particular colon polyps, it is to be understood that the object segmentation and shape characterization methods presented herein have application to 3D CT images, and to images from different modalities of any dimensions on which a toboggan type potential can be computed. Systems and methods for toboggan based object segmentation are disclosed in these inventors' copending patent applications, “System and Method for Toboggan-based Object Segmentation using Distance Transform”, U.S. patent application Ser. No. 11/______, filed Jun. 6, 2005, and “System and Method for Dynamic Fast Tobogganing”, U.S. patent application Ser. No. 11/______, filed Jun. 6, 2005, the contents of both of which are incorporated herein by reference in their entirety.

As used herein, the term “image” refers to multi-dimensional data composed of discrete image elements (e.g., pixels for 2-D images and voxels for 3-D images). The image may be, for example, a medical image of a subject collected by computer tomography, magnetic resonance imaging, ultrasound, or any other medical imaging system known to one of skill in the art. The image may also be provided from non-medical contexts, such as, for example, remote sensing systems, electron microscopy, etc. Although an image can be thought of as a function from R³ to R, the methods of the inventions are not limited to such images, and can be applied to images of any dimension, e.g. a 2-D picture or a 3-D volume. For a 2- or 3-dimensional image, the domain of the image is typically a 2- or 3-dimensional rectangular array, wherein each pixel or voxel can be addressed with reference to a set of 2 or 3 mutually orthogonal axes. The terms “digital” and “digitized” as used herein will refer to images or volumes, as appropriate, in a digital or digitized format acquired via a digital acquisition system or via conversion from an analog image.

According to an embodiment of the invention, a toboggan cluster can be obtained by first binarizing an image and then performing fast tobogganing using a dynamic distance transform. It is to be understood that this method of obtaining a toboggan cluster is non-limiting, and other techniques of obtaining a toboggan cluster are within the scope of an embodiment of the invention. Once a toboggan cluster has been formed, various features can be computed on the cluster. Since a toboggan cluster is formed of points that have slid to a common concentration point, a toboggan cluster is a contiguous set of points. Objects can be characterized in terms of features, which can be categorized as pixel-based, cluster-based and toboggan layer-based.

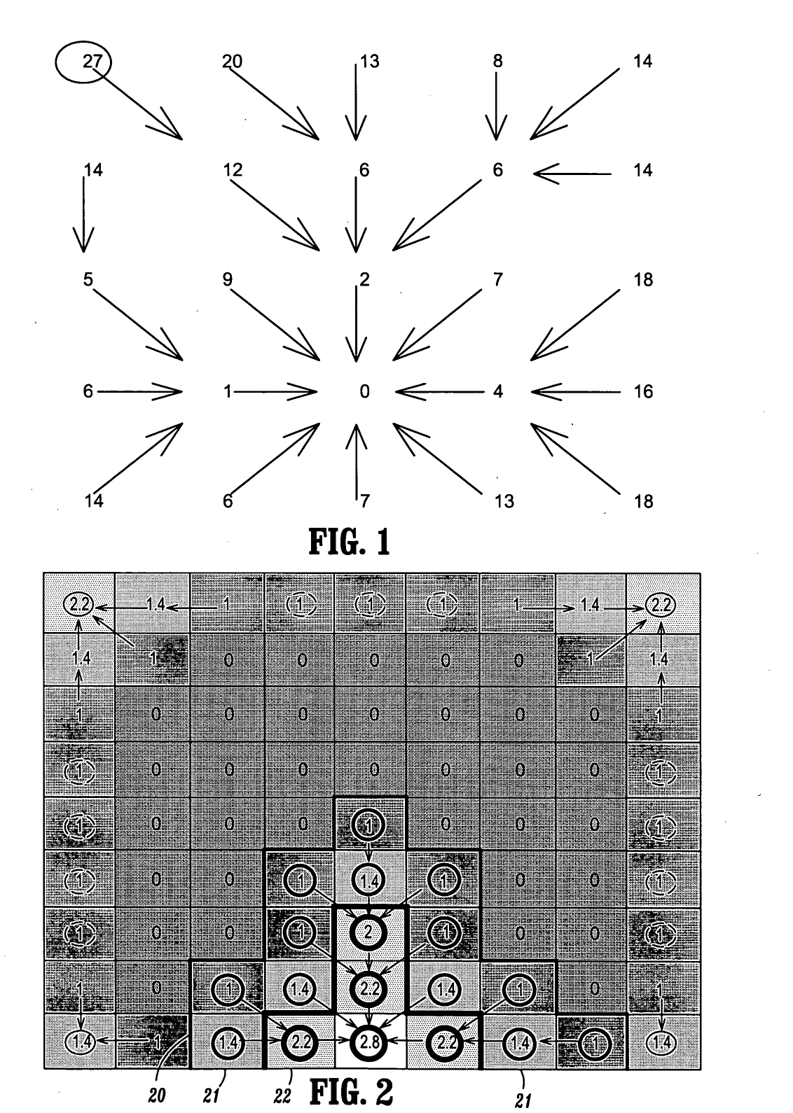

FIG. 1 depicts a non-limiting example illustrating the tobogganing process given a 5×5 2D toboggan potential, according to an embodiment of the invention. Each number represents the toboggan potential value at each pixel. In this example, each pixel slides to its neighbor with a minimal potential, as indicated by the arrows in the figure. In other situations, a pixel can be slid to a neighbor with a maximal potential. All of the pixels shown here slide to the same location, called a concentration location, with potential of 0, forming a single cluster. The concentration location is a pixel with an extremal potential value, either a maximum or a minimum, so that it cannot slide to any of its neighbors.

Each pixel in a formed cluster has an intensity and intensity-gradient magnitude. In addition, several other pixel-based features can be computed for the toboggan cluster.

One set of pixel based features include the direct distance, sliding distance and their ratio. The direct distance d of a pixel is defined as the Euclidean distance from the pixel to its concentration location, while the sliding distance s of a pixel in a toboggan cluster is defined as the length of its sliding path to its concentration location. The sliding distance will typically be greater in magnitude than the direct distance. The ratio is of course defined as d/s. The magnitude of the ratio is a measure of the sphericity of the cluster. A large ratio magnitude, that is, a ratio value close to 1.0, is indicative of a spherical- or half-spherical shaped cluster.

As an example, referring again to FIG. 1, the sliding distance of the circled pixel in the figure is \sqrt{2}+\sqrt{2}+1=3.8284, while its direct distance is \sqrt{(3−1)²+(4−1)²}=3.6506, and the direct/sliding distance ratio is 3.6506/3.8284=0.9418.

Another set of pixel based features include the normal direction, sliding direction and their consistency. The normal direction is determined by the derivatives of the original image, i.e., the direction of the intensity gradient. The sliding direction is defined as the direction from the pixel to its concentration location. Their consistency is computed as the inner product of the two directions. This product can be normalized to unity. The consistency of the normal direction to the sliding direction is another indicator of the sphericity of a cluster. A greater magnitude of the consistency value indicates a sliding direction and normal direction that are more closely parallel, and a cluster that is more spherical in shape.

Cluster-based features include those measurements that can be computed based on the whole extracted toboggan cluster, for instance, the longest linear dimension, the volume, etc. Another useful cluster based feature is the sphericity. One technique of calculating sphericity involves first computing the covariance matrix C of the extracted pixels' coordinates, and then computing the eigenvalues of the covariance matrix. The covariance in N-dimensions can be defined by Cᵢⱼ=<(xᵢ−μᵢ)(xⱼ−μⱼ)>, where xᵢ is a pixel coordinate and μᵢ is the mean coordinate for the i^{th} dimension. In 2-dimensions, there are two eigenvalues (e₁, e₂) and one ratio e₁/e₂. In 3-dimensions, there are three eigenvalues (e₁, e₂, e₃) and three ratios (r₁=e₁/e₂, r₂=e_{1/e}₃, r₃=e₂/e₃). The three eigenvalues are non-negative and sorted so that 0≦e₁≦e₂≦e₃. The eigenvalues and their ratio capture the sphericity of the cluster. A spherical or half-spherical cluster will have eigenvalue ratios that are equal or almost equal. On the other hand, a 3D cluster with two eigenvalues nearly equal to each other and not equal to the third eigenvalue will be more cylindrical or disk-like in shape. Differing eigenvalues will tend to characterize ellipsoidal structures.

Cluster based features also include statistical properties of the pixel-based features, for instance, the moments of the intensity, gradient magnitude, direct distance, sliding distance, direct/sliding ratio, consistency of normal direction and sliding direction, etc.

The topological or geometrical properties of a toboggan cluster can also be characterized by Fourier descriptors, obtained by Fourier transforming the pixel intensities of the cluster. Other descriptors, such as wavelets, can also be used for this purpose.

A toboggan cluster is a layered structure. Another set of cluster features can be computed from the toboggan layers themselves. To do so, the toboggan layers need to be extracted from the cluster.

Generally speaking, the first toboggan layer is the toboggan surface, which includes those pixels to which no other pixels slide. The second layer those pixels that are neighbors to the first layer. In general, the n^{th} toboggan layer includes those pixels that are neighbors to the previous, i.e. the (n-1)^{th}, layer.

According to an embodiment of the invention, a toboggan potential can be computed using the dynamic distance transform. The toboggan layers can then be extracted based on the potential values. For example, the first layer, i.e. the toboggan surface, includes those pixels with potential smaller than 2, the second layer includes those pixels with potential greater than 2 but less than 3, and the third layer are those pixels with potential greater than 3 but less than 4.

FIG. 2 depicts a toboggan cluster with two layers, according to an embodiment of the invention. For simplicity of discussion only one such cluster 20 is shown. Pixels 21 marked with light gray circles identify the surface layer of the toboggan cluster 20. The next layer 22 is marked with dark gray circles. Larger clusters would have more layers than are depicted in the figure.

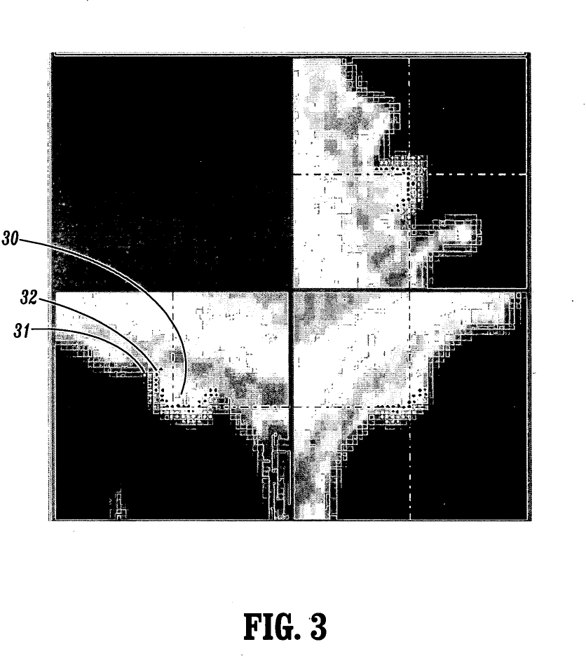

FIG. 3 depicts two extracted layers for one of the cluster associated with a structure from the center of a 3D volume, according to an embodiment of the invention. The three panels in the figure are three orthogonal views of the same three-dimensional object. For simplicity, only the lower left panel is labeled. Cluster 30, which is associated with a colon polyp, includes a surface layer 31, indicated by the light gray dots, and a second layer 32, indicated by the dark gray dots.

Once a toboggan layer is extracted, a plurality of features can be computed based on the layer. These features include, but are not limited to, the statistical moments of the pixel intensity in the layer, the statistical moments of the pixel toboggan potential in the layer, the sphericity of the layer, direct distance, sliding distance, direct/sliding ratio, and consistency of normal direction with sliding direction.

These features allow each layer to be characterized according to topological, geometrical and density related properties. Topological and geometrical properties include shape related properties, such as sphericity, while density related properties are those properties calculated from the statistical moments of the layers. For instance an analysis of the intensity distribution within a layer could reveal that one or more portions/sections of the layer is less dense than the rest of the layer.

The toboggan layer structure also enables the computation of features crossing different toboggan layers to see how feature values change across the different layers, such as the change of intensity values across toboggan layers. For example, one could compute statistical moments based on intensity values or toboggan potential values associated with each individual layer and then determine how these moments change across layers. Referring to FIG. 2, one could compute the gradient of the intensity or potential statistical moments as a function of the layers. For example, a mean intensity value could be computed with respect to the surface layer 21, and then with respect to the second layer 22, and with any other layer present all the way to the concentration point. An average rate of change of the mean intensity can be computed to illustrate the overall change of the intensity across the layers. Alternatively, a rate of change could be calculated as a function of layers with respect to a coordinate system centered in the proximity of or at the concentration point of a cluster.

The topological or geometrical change across the toboggan layers can also be characterized. For instance, the shape of each layer can be characterized by Fourier descriptors, obtained by Fourier transforming the pixel intensities of each layer. The rate of change of the Fourier descriptors across the toboggan layers is another technique for characterizing the object of the toboggan cluster. Other descriptors, such as wavelets, can also be used for this purpose.

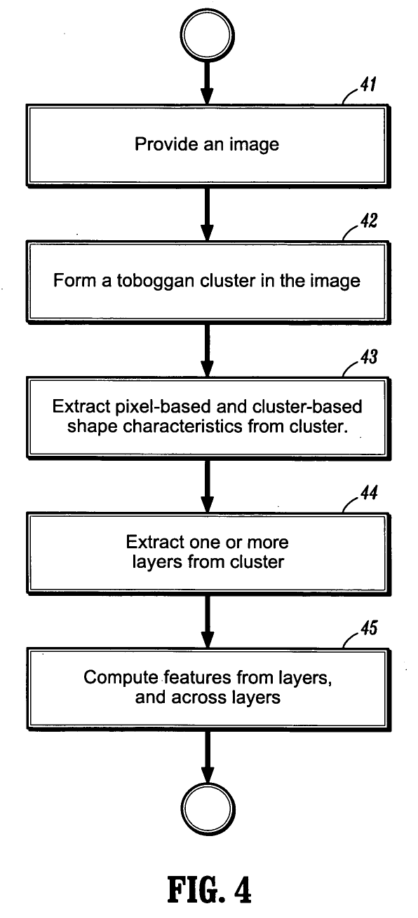

FIG. 4 depicts a flow chart of a toboggan-based object characterization method, according to an embodiment of the invention. The process starts at step 41 by providing an image to be segmented. The image should be in digital form, although the image could a digitized version of an analog image. The image can be produced by any imaging modality as is known in the art, such as MR, CT, PET, US, etc. At step 42, tobogganing is performed on the image to form a toboggan cluster. Tobogganing can be performed by the techniques disclosed in these inventor's co-pending patent applications, “System and Method for Toboggan-based Object Segmentation using Distance Transform”, U.S. patent application Ser. No. 11/______, filed Jun. 6, 2005, and “System and Method for Dynamic Fast Tobogganing”, U.S. patent application Ser. No. 11/______, filed Jun. 6, 2005. Once a toboggan cluster has been formed and identified, pixel and cluster-based features can be extracted as described above. In addition, one or more layers can be extracted from the toboggan cluster at step 44, and, at step 45, cluster features can be extracted and computed for each layer, as described above, and across the layers to determine how feature values vary as a function of layer, as described above. The steps of forming a toboggan cluster 42, extracting pixel and cluster based features 43, extracting layers form the cluster 44, and computing features form the layers 45 can be repeated for other clusters in the image.

According to another embodiment of the invention, there can be cases where the object of interest is broken into multiple toboggan clusters and a merging strategy would be required. In this case, those toboggan clusters which together represent the object of interest need to be merged into one big cluster. Various criteria can be used for selecting toboggan clusters for merging. Such a cluster would have more than one concentration point, and the concentration points can include both minima and maxima. However, each pixel in a combined cluster will still toboggan to one concentration point, and thus the pixel based features such as sliding distance, direct distance, normal direction and sliding direction, can still be used to characterize the cluster. In addition, the cluster-based and the layer-based features can also be used to characterize the cluster object, as disclosed herein above.

It is to be understood that the present invention can be implemented in various forms of hardware, software, firmware, special purpose processes, or a combination thereof. In one embodiment, the present invention can be implemented in software as an application program tangible embodied on a computer readable program storage device. The application program can be uploaded to, and executed by, a machine comprising any suitable architecture.

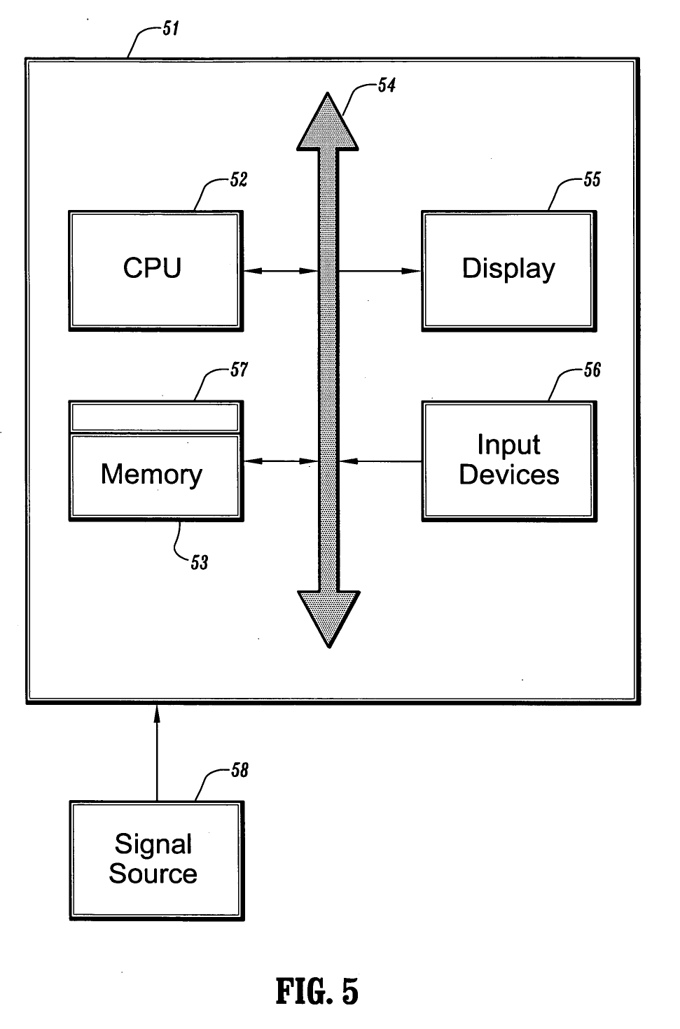

FIG. 5 is a block diagram of an exemplary computer system for implementing a toboggan-based object characterization scheme according to an embodiment of the invention. Referring now to FIG. 5, a computer system 51 for implementing the present invention can comprise, inter alia, a central processing unit (CPU) 52, a memory 53 and an input/output (I/O) interface 54. The computer system 51 is generally coupled through the I/O interface 54 to a display 55 and various input devices 56 such as a mouse and a keyboard. The support circuits can include circuits such as cache, power supplies, clock circuits, and a communication bus. The memory 53 can include random access memory (RAM), read only memory (ROM), disk drive, tape drive, etc., or a combinations thereof. The present invention can be implemented as a routine 57 that is stored in memory 53 and executed by the CPU 52 to process the signal from the signal source 58. As such, the computer system 51 is a general purpose computer system that becomes a specific purpose computer system when executing the routine 57 of the present invention.

The computer system 51 also includes an operating system and micro instruction code. The various processes and functions described herein can either be part of the micro instruction code or part of the application program (or combination thereof) which is executed via the operating system. In addition, various other peripheral devices can be connected to the computer platform such as an additional data storage device and a printing device.

It is to be further understood that, because some of the constituent system components and method steps depicted in the accompanying figures can be implemented in software, the actual connections between the systems components (or the process steps) may differ depending upon the manner in which the present invention is programmed. Given the teachings of the present invention provided herein, one of ordinary skill in the related art will be able to contemplate these and similar implementations or configurations of the present invention.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed is:

1. A method for characterizing an object in a digitized image comprising the steps of:
providing a digitized volumetric image comprising a plurality of intensities corresponding to a domain of points in an N-dimensional space;
forming a toboggan cluster from a subset of contiguous points in said image, said toboggan cluster including a concentration point;
extracting a first layer from said toboggan cluster; and
computing one or more features from said toboggan layer.

2. The method of .claim 1, wherein said first layer comprises a surface layer of said toboggan cluster, which comprises those cluster points to which no other cluster points slide.

3. The method of claim 1, wherein said features include one or more of the statistical moments of the point intensities of the points in said layer, the statistical moments of the toboggan potential values of the points in said layer, the sphericity of said layer, a direct distance and sliding distance of each point in said layer, a ratio of said direct distance to said sliding distance, or a consistency of a normal direction to a sliding direction of each point in said layer.

4. The method of claim 1, wherein each point in said cluster has a toboggan potential value, and further comprising extracting one or more layers from said toboggan cluster wherein each layer comprises cluster points whose toboggan potential value is within a predetermined range.

5. The method of claim 4, further comprising computing, for each layer, one or more statistical moments of the intensities of the points in each said layer, and computing a rate of change of said statistical moments across said layers.

6. The method of claim 5, wherein said rate of change is computed with respect to a coordinate system centered on the concentration point of said cluster.

7. The method of claim 5, further comprising computing one or more Fourier descriptors of said rate of change.

8. The method of claim 5, further comprising computing one or more wavelet descriptors of said rate of change.

9. The method of claim 4, further comprising computing, for each layer, one or more statistical moments of the toboggan potentials of the points in each said layer, and computing a rate of change of said statistical moments across said layers.

10. The method of claim 9, wherein said rate of change is computed with respect to a coordinate system centered on the concentration point of said cluster.

11. The method of claim 9, further comprising computing one or more Fourier descriptors of said rate of change.

12. The method of claim 9, further comprising computing one or more wavelet descriptors of said rate of change.

13. The method of claim 1, wherein said toboggan cluster includes a plurality of concentration points.

14. A method for characterizing an object in a digitized image comprising the steps of:
extracting a toboggan cluster from a digitized volumetric image, said toboggan cluster comprising a set of contiguous points in said image, each point having an intensity value;
computing one or more shape characteristics of said toboggan cluster.

15. The method of claim 14, wherein said digitized volumetric image comprising a plurality of intensities corresponding to a domain of points in an N-dimensional space.

16. The method of claim 14, wherein said shape characteristics include sphericity, and wherein computing a sphericity further comprises computing a covariance matrix for said cluster from the coordinates of the points in said cluster, computing the eigenvalues of said covariance matrix, and computing the ratios of the eigenvalues.

17. The method of claim 14, wherein said cluster has a concentration point, and wherein computing a shape characteristic further comprises determining, for each point in said cluster, a direct distance to said concentration point, a sliding distance to said concentration point, and a ratio of said direct distance to said sliding distance.

18. The method of claim 17, further comprising computing for said cluster one or more statistical moments of said direct distance, said sliding distance, and said ratio.

19. The method of claim 14, wherein said cluster has a concentration point, and wherein computing a shape characteristic further comprises determining, for each point in said cluster, a normal direction, a sliding direction to said concentration point, and an inner product of said normal direction and said sliding direction,

20. The method of claim 19, further comprising computing for said cluster one or more statistical moments of said normal direction, said sliding direction, and said inner product.

21. A program storage device readable by a computer, tangibly embodying a program of instructions executable by the computer to perform the method steps for characterizing an object in a digitized image comprising the steps of:
providing a digitized volumetric image comprising a plurality of intensities corresponding to a domain of points in an N-dimensional space;
forming a toboggan cluster from a subset of contiguous points in said image, said toboggan cluster including a concentration point;
extracting a first layer from said toboggan cluster; and
computing one or more features from said toboggan layer.

22. The computer readable program storage device of claim 21, wherein said first layer comprises a surface layer of said toboggan cluster, which comprises those cluster points to which no other cluster points slide.

23. The computer readable program storage device of claim 21, wherein said features include one or more of the statistical moments of the point intensities of the points in said layer, the statistical moments of the toboggan potential values of the points in said layer, the sphericity of said layer, a direct distance and sliding distance of each point in said layer, a ratio of said direct distance to said sliding distance, or a consistency of a normal direction to a sliding direction of each point in said layer.

24. The computer readable program storage device of claim 21, wherein each point in said cluster has a toboggan potential value, and further comprising extracting one or more layers from said toboggan cluster wherein each layer comprises cluster points whose toboggan potential value is within a predetermined range.

25. The computer readable program storage device of claim 24, the method further comprising computing, for each layer, one or more statistical moments of the intensities of the points in each said layer, and computing a rate of change of said statistical moments across said layers.

26. The computer readable program storage device of claim 25, wherein said rate of change is computed with respect to a coordinate system centered on the concentration point of said cluster.

27. The computer readable program storage device of claim 25, the method further comprising computing one or more Fourier descriptors of said rate of change.

28. The computer readable program storage device of claim 25, the method further comprising computing one or more wavelet descriptors of said rate of change.

29. The computer readable program storage device of claim 24, the method further comprising computing, for each layer, one or more statistical moments of the toboggan potentials of the points in each said layer, and computing a rate of change of said statistical moments across said layers.

30. The computer readable program storage device of claim 29, wherein said rate of change is computed with respect to a coordinate system centered on the concentration point of said cluster.

31. The computer readable program storage device of claim 29, the method further comprising computing one or more Fourier descriptors of said rate of change.

32. The computer readable program storage device of claim 29, the method further comprising computing one or more wavelet descriptors of said rate of change.

33. The computer readable program storage device of claim 21, wherein said toboggan cluster includes a plurality of concentration points.
